(19) United States
(12) Patent Application Publication
(10) Pub. No.: US 2013/0204600 A1
(43) Pub. Date: Aug. 8, 2013

(54) Virtual articulator

(71) Applicant: Tarun Mehra, Calgary (CA)

(72) Inventor: Tarun Mehra, Calgary (CA)

(73) Assignee: Tarun Mehra, Calgary (CA)

(21) Appl. No.: 13/366,529

(22) Filed: Feb. 6, 2012

(51) Int. Cl. G06G 7/60

(52) U.S. Cl. 703/11

(57) ABSTRACT

The invention is a three dimensional virtual articulator used for but not limited to diagnosing and treatment planning for dental and medical specialties, including orthodontics, prosthodontics, endodontics, periodontics, orthognathic surgery, implant positioning, crown and bridge and prosthesis design.

The operator enters patient-specific anatomical measurements for condylar angles, Bennett angle and shift, lateral excursive and protrusive movements, and maximum mandibular opening, and a selection of preset or customizable intercondylar distances to simulate the unique mandibular range of motion.

The patient-specific measurements create a customized complex polygon that illustrates the maximum limits of the mandibular range of motion. The operator is able to use onscreen controls to move the virtual mandible in relation to the virtual maxilla within the parameters described by the patient-specific measurements input by the operator.

The first point of contact as well as surface interferences can be marked on the dynamic surfaces of the two virtual arches.

### BACKGROUND OF THE INVENTION

In all references, digital models are considered the same as a virtual models or computer generated models, all of which are three dimensional representations for the purposes of this patent.

In all references, a virtual articular is considered the same as a digital articulator.

The illustrations and drawings attached to this document form an integral part of the submission and should be used in conjunction with the text, as referenced, to aid in a full understanding of the invention.

This invention, called a virtual articulator, is a method of articulating three dimensional virtual/digital models to simulate a patient's natural jaw movement originating in the temporomandibular joints, for use in but not limited to the dental, medical and surgical specialties such as orthodontics, prosthodontics, endodontics, oral-maxillofacial surgery, periodontics, oral medicine, and for diagnostics and treatment planning and the manufacture of dental, medical and orthodontic appliances.

In treating a patient for dental, medical and orthodontic concerns, the clinician utilizes a number of tools to establish the dental or medical problem, to measure and evaluate a patient's dental health and diagnose disease, syndromes, disorders, dysfunctions and disfigurements.

A patient's dental anatomy and health are determined by the interaction of various factors including dental alignment and the patient's skeletal anatomy as it pertains to the range and direction of mandibular motion, as well as the condition of the temporomandibular joint (TMJ).

The shape and size of teeth, skeletal anatomy, and mandibular range of motion is unique for each patient. The function and occlusion of the patient's jaws and teeth is complex. Understanding how a patient's dental alignment is established and how it functions within the patient's masticatory system is fundamental in diagnosing and treating a patient's malocclusion and other dental and medically related conditions. There are several muscular and anatomical factors involved that will alter the way the mandible and maxilla, as well as the teeth, interact, and affect the range of motion of the mandible.

Over time, a patient's teeth will alter their respective positions within the maxillary and the mandibular arches to find the most stable and comfortable position within each arch and between the two arches. Teeth positions within the dental arches and inter-arch teeth alignments are determined by several anatomical factors, including the muscular balance of the teeth with the surrounding muscles of mastication, the shape and dimension of the condyles and the articular fossae. Poor alignment of one or several teeth in one arch may lead to the occluding teeth in the opposing arch to change position to adjust to new occlusal position, or may cause either the mandible or the maxilla to adapt to the misalignment by becoming malformed.

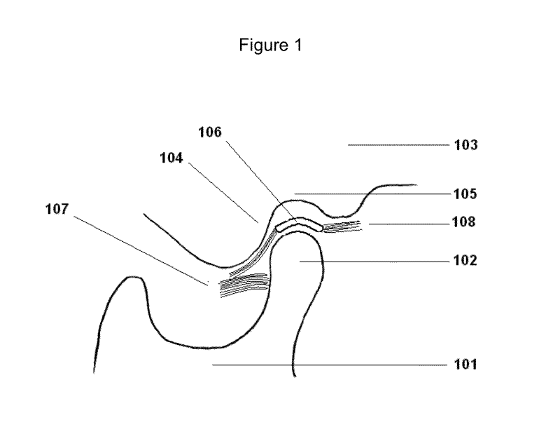

The anatomical points of the temporomandibular joints (TMJ) that are relevant in the movement of the jaw are illustrated in FIG. 1. The TMJ are the joints on the left and right sides of the head and are the mechanism by which the mandible opens and closes, moves excursively left and right, as well as protrusively and retrusively. Each TMJ consists of the mandible (101), a condyle (102), and the temporal bone (103), with the articular eminence (104) and the articular fossa (105). The articular disc (106) resides between the articular fossa (105) and the condyle (102).

The muscles connected to the bones of the TMJ are the superior and inferior lateral pterygoid (107) and, posteriorly, the retrodiscal tissues (108). The mandibular range of motion is predicated by the interaction and function of the individual's unique skeletal anatomy and the muscles of mastication.

The size and shape of the articular eminence within the TMJ is one of several anatomical factors that influence the direction and mandibular range of motion. Studies have documented that the articular eminence changes in shape and dimension during the growth phase of a patient. Furthermore, there can also be differences in the anatomical structures form the left and right sides. The condylar angles, which are also known as the articular eminence inclinations, affect the location of the first point of contact between the maxillary and mandibular arches, as well as the location and pattern of surface interferences between the two arches.

The Bennett movement and Bennett shift are the lateral movements of the condyles and are determined by the shape of articular fossa and the musculature that translates lateral displacement of the condyles on the vertical axis.

When the mouth is closed, the maxillary and mandibular dental arches rest or occlude in one of two positions. The centric occlusion, CO, is where the occlusal surfaces of the teeth have the maximum intercuspation or physical contact between the teeth of the maxilla and mandible. The centric relation, CR, is where the head of the condyle is situated in the most anterior and superior position possible within the articular fossa. In an ideal occlusion CO and CR are coincident. However, there are dental and medical conditions where the CO and CR positions are not in alignment and there is a discrepancy. Consequently, some patients will exhibit a shift in mandibular motion from the CO to CR position and vice versa.

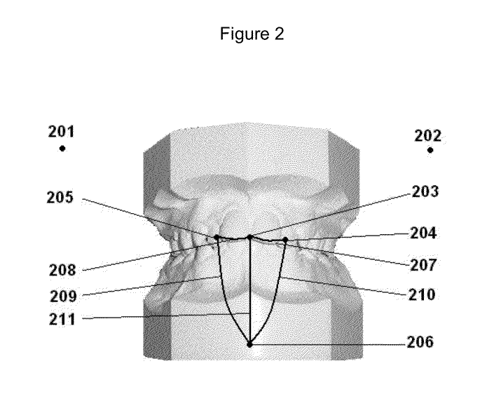

FIG. 2 is an illustration of a curvilinear polygon superimposed on a three dimensional virtual model. The polygon represents the mandibular range of motion as viewed from the front. Points 201 and 202 are the right and left condyles. Point 203 marks the starting point of either the CO or CR occlusion of the digital model. Points 204 and 205 are the left-most and right-most range for lateral excursive movement from point 203, while point 206 marks the maximum limit that point 203 can attain when the mandible has reached the furthest opening possible. Line 207 is the curvilinear path followed by point 203 during left lateral excursive movement, while line 208 is the curvilinear path followed by point 203 during right lateral excursive movement. Lines 209 and 210 are the curvilinear representations of the path of motion that points 204 or 205 will follow while the mandible moves from the closed position towards the maximum mandibular opening (206) when the mandible is extended to the maximum limit of right or left lateral excursive position. Line 211 is the path of motion that point 203 will follow while the mandible moves from the closed position towards the maximum mandibular opening (206) when the mandible is in its maximum protrusive position.

Mandibular movement can be both rotational and translational. The dental anatomy is determined by, and influenced by, the movement of the mandible through the rotation and translational mandibular range of motion.

Rotational movement can be described in each of the three dimensions, transverse, sagittal and coronal. As viewed on the transverse plane, the opening and closing of the mandible is referred to as the hinge motion. From the coronal plane, the movement is a rotation of one condyle as the opposing condyle orbits laterally and medially. As viewed on the sagittal plane, the orbiting condyle rotates as the mandible moves inferiorly as the opposing condyle remains in the terminal hinge position. The maximum limits of motion in each direction will establish the curvilinear conical three dimensional range of motion polygon.

The movement of the mandible becomes translational when mandible reaches the maximum possible opening within the hinge axis before the articular disc begins to move. After this point, the articular disc moves in the same direction as the condyles. From either the CO or CR position, the mandible opens in a pure hinge type of motion that is established by a virtual axis defined by the left and right TMJ. As the mandible opens, there will be a point where the condyles have moved as far as they can without moving the articular disc. The movement will then translate as the disc shifts and the arch of mandibular opening will change.

Lateral excursive movements occur as the maxillary and mandibular teeth slide over one another as the orbiting condyle moves medially and the non-orbiting condyle remains stationary in the hinge axis position. Lateral excursive movements are complex curvilinear motions that occur simultaneously in all three planes.

In a perfectly aligned occlusion of dental arches, protrusive or forward movement slides the mandible forward until the mandibular incisors make contact with the incisal edges of the maxillary incisors. The movement then transitions into an inferior displacement of the mandible as the mandibular incisors pass the maxillary incisal edges. The posterior tooth contacts are cleared with continued protrusive movement resulting in superior movement of the mandibular incisor. At this point, the mandible is free to move to the furthest protrusive position in a non linear vector. This movement will differ from patient to patient.

Within the horizontal plane of motion, the intercondylar distance, which is the distance between the left and right TMJ, will affect the, rotational arch of movement for left and right lateral excursive movement of the mandible. A greater intercondylar distance will result in a smaller rotational arch angle for lateral and medial excursive movements, while a smaller intercondylar distance results in a larger rotational arch angle. The differences in the intercondylar distances impact the natural shape of a patient's teeth.

Large Bennett shifts and Bennett angles will have the effect of increasing the arch angle of mandibular movement for left and right lateral excursive, which will affect the shape and dimension of the natural teeth and are a factor in the fabrication of crowns and other prostheses. Specifically, greater Bennett shifts and Bennett angles will result in shorter cusp heights of the posterior teeth.

The Curve of Spee and anterior guidance are also factors that affect the range of motion of mandible and the design of appliances. The curve of Spee is defined as the curvature of the occlusal plane along the surfaces of the teeth from the posterior molar to the incisors. A large the curve of Spee will result in shorter cusps of molars that are posterior, whereas the premolars will have longer cusps. These variations must also be considered in the fabrication of crowns and prostheses.

The anterior guidance is the displacement of the maxillary and mandibular incisors in protrusive movement. Proclined maxillary or mandibular incisors reduce the degree of anterior guidance as the mandible moves in a protrusive position. There will be less inferior displacement of the lower incisors as the maxillary and mandibular incisors slide past one another. Conversely, retroclined maxillary and mandibular incisors will result in the greater anterior guidance and will result in more inferior displacement of the mandible in protrusive movement. The anterior guidance affects the tooth interference between the maxillary and mandibular dental arches, which must also be taken in to consideration when diagnosing and treatment planning for orthognathic surgery, implant positioning, crown, bridge and prosthesis design.

One of the tools used in the diagnosis and planning process is a dental articulator, which allows the clinician to mount a set of plaster or orthodontic stone dental models in such a way as to reproduce each individual patient's mandibular movements as accurately as possible. The purpose of the device is to mimic the patient's mandibular range of motion and highlight any deviations in movement. The articulator can be used to mark the degree of tooth interferences occurring during lateral excursive, protrusive and retrusive movements.

To manufacture the plaster or stone models, the clinician uses a rubber base or natural-based material to take a dental impression of the maxillary and mandibular dental arches. Orthodontic plaster or stone is used to fill the contours of the impression, which then solidifies to form an accurate representation of a patient's teeth and gums. The two arches of the model are mounted on the manual articulator and a bite registration is used to occlude the models, aligning the arches to match that of the patient.

Diagnosis and treatment planning technology has changed in recent years to replace the stone or plaster mandibular and maxillary dental models with three dimensional digital representations. Scanning technologies can create a virtual environment whereby the clinician can view a virtual three dimensional intraoral representation of the maxillary and mandibular dentition with reasonable accuracy. Computer applications exist on which three dimensional segments of teeth and soft tissue areas can be moved within an arch. There are also programs that allow the user to place virtual orthodontic brackets on the digital models for use in determining actual bracket placement.

A high degree of accuracy in the virtual three dimensional representation of a patient's dentition, anatomy and mandibular range of motion is required to formulate the ideal course of treatment for a patient, which includes but is not limited to the fabrication of accurate dental restorations and appliances, creation of orthognathic surgical treatment plans, determination of surgical implant positioning and fabrication of implant prostheses.

However, the existing computer applications do not include measurement and movement indicators that are vital to accurate diagnosis and treatment planning as well as crown and prosthesis manufacturing. None of the current applications will accurately register the first point of contact on the surfaces of the virtual model during normal movement as well as the interference of the surfaces of the two virtual arches resulting from the virtual mandibular movements. Also, there is no application that illustrates the mandibular range of motion of the virtual three dimensional dental models that can be made with specific anatomical measurements for each individual. Nor is there a function that will allow for differentiation between surface interference patterns resulting from mandibular movement within the individual's range of motion. The virtual articulators that are on the market presently do not allow the user to input patient-specific anatomical measurements that define the unique mandibular range of motion.

A customizable virtual articulator application that includes the ability to enter patient-specific data will present a method to more accurately design a treatment plan, including direct or indirect bonding of orthodontic brackets, as well as appliance and prosthesis design. This invention is a three dimensional virtual articulator which is designed to replace manual articulators and enhance the technological tools already available in that it is more versatile and performs a more accurate representation of actual patient-specific mandibular movement for, but not limited to, diagnosing and treatment planning for orthognathic surgery, implant positioning, crown and bridge and prosthesis design.

### SUMMARY OF THE INVENTION

The invention is a three dimensional virtual articulator used for but not limited to diagnosing and treatment planning for dental and medical specialties, including but not limited to orthodontics, prosthodontics, endodontics, periodontics, oral medicine, orthognathic surgery, implant positioning, crown and bridge and prosthesis design.

The invention is designed so it can be used with any computer-generated three dimensional digital representations of a patient's maxillary and mandibular anatomy. Files from any scanning system that produces three dimensional closed-surface STL or stereo lithographic data format can be processed for use with this invention.

The virtual articulator allows the operator to manipulate one component of a three dimensional model in relation to the other, for the purposes of this example, the mandibular dental arch in relation to the maxillary arch for diagnostic and treatment planning, as well as for manufacturing purposes. The topographical surfaces of the dental arches are constructed with a virtual closed-surface polygon mesh. The surfaces are dynamic and can register the first point of contact between the surfaces of the individual components, as well as surface or tooth interferences. The invention is designed to closely approximate any patient's personalized mandibular range of motion with the input of patient-specific measurements. Additionally, the occluded digital models can be rotated 360° in all and in any combination of movement in three dimensions.

The operator enters patient-specific anatomical values for the left and right condylar angles, left and right Bennett angles, left and right Bennett shifts, left and right maximum lateral excursive movements, and the maximum protrusive movement and maximum mandibular opening limits to simulate the unique mandibular range of motion. The virtual articulator includes preset measurements for intercondylar distance for two common manual articulators, or the data can be customized. This data is automatically saved in the system until such time as it is reset by the operator. The data set can be changed one item at a time or the entire date set can be cleared and new data entered as required.

The operator is able to move the mandibular dental arch in relation to the maxillary dental arch. Movement of the virtual mandible can be any combination of left or right excursive, open or close, retrusive or protrusive. Left and right Bennett shifts can also be simulated.

When the virtual articulator function is launched, the first point of contact between the components of the three dimensional digital model is indicated by a coloured mark. Interference contact points between the upper and lower components of the three dimensional digital models upon movement are also identified with a series of coloured marks.

Articulation can be reset to the opening or default view and the number of re-articulations that can be performed is unlimited.

These and the various other attributes, features and uses of the invention which are unique and novel are noted with clarity in the claims annexed to this document and form part hereof. For a better understanding of the invention, the reader should refer to the diagrams which are attached and also form part hereof this submission.

### BRIEF DESCRIPTION OF THE DIAGRAMS

FIG. 1 Anatomy of the Temporomandibular joint

FIG. 2 Range of Motion polygon

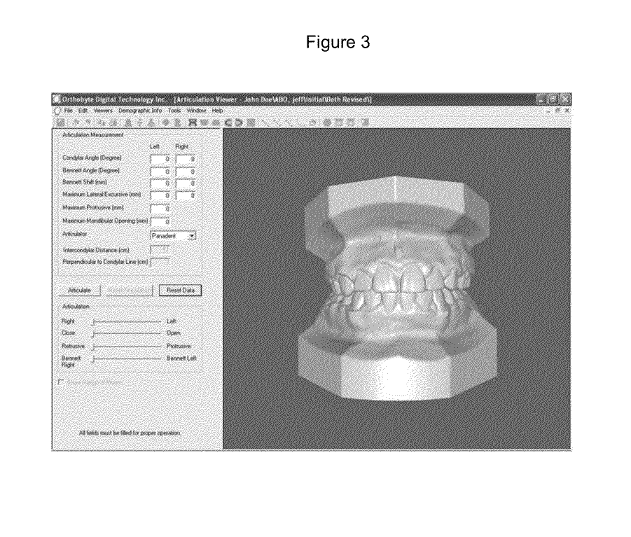

FIG. 3 Virtual articulator screen with standard model

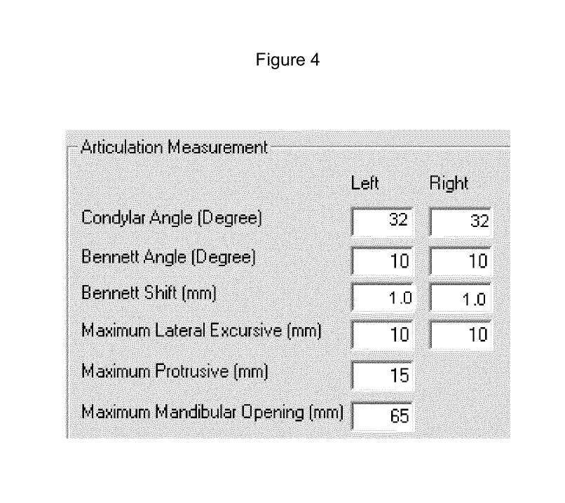

FIG. 4 Customizable fields for patient range of motion parameters

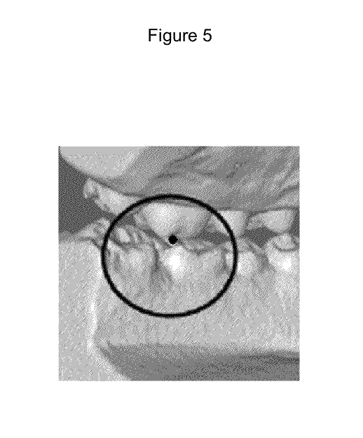

FIG. 5 Coloured mark indicating the first point of contact upon closing the bite

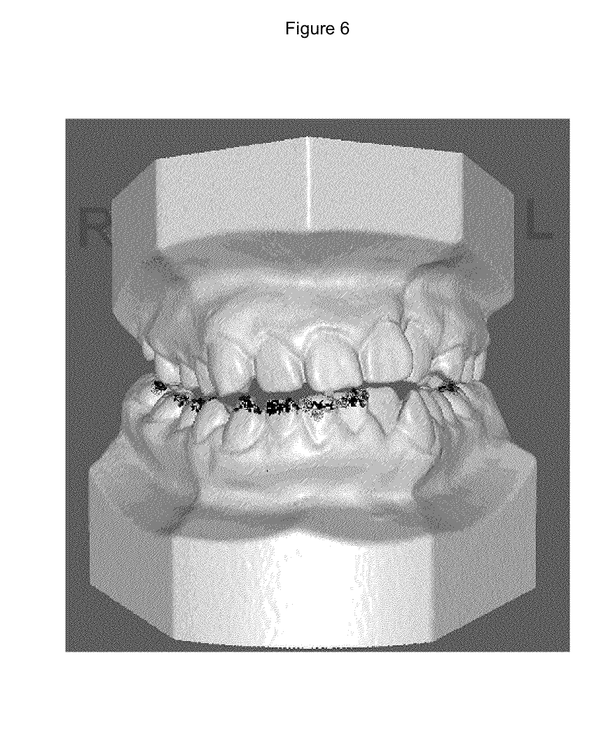

FIG. 6 Coloured marks indicating the surface interferences between the dynamic surfaces of the virtual arches

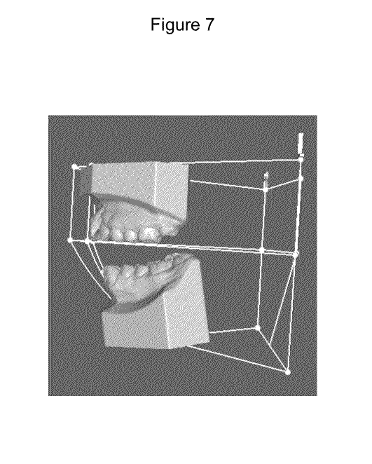

FIG. 7 Range of Motion polygons

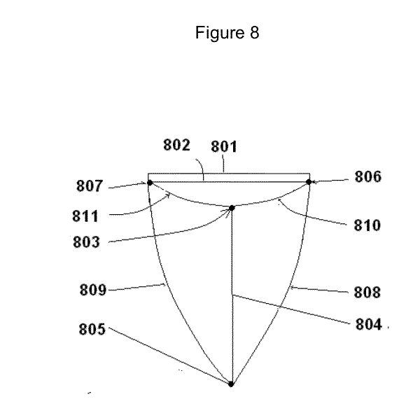

FIG. 8 Mandibular Range of Motion, Front view

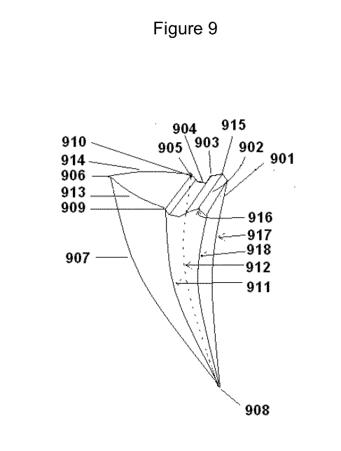

FIG. 9 Mandibular Range of Motion, Side view

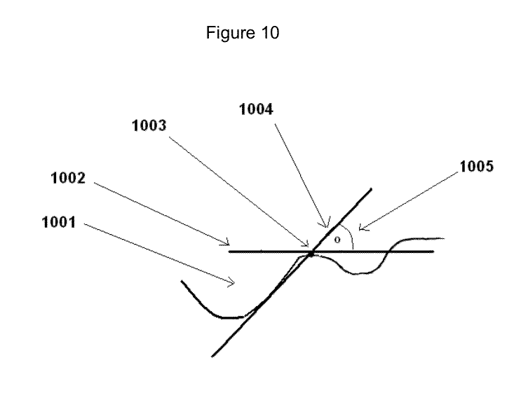

FIG. 10 Condylar angle

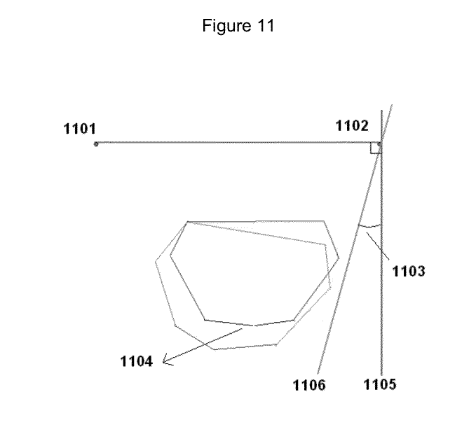

FIG. 11 Bennett Angle

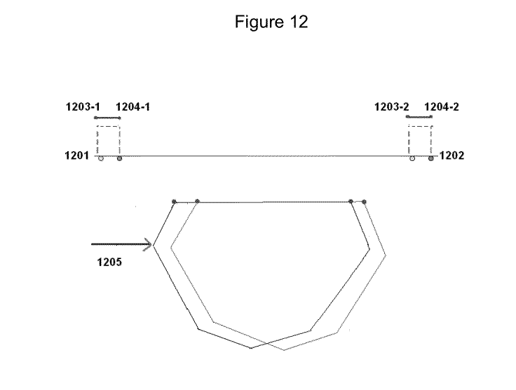

FIG. 12 Bennett Shift

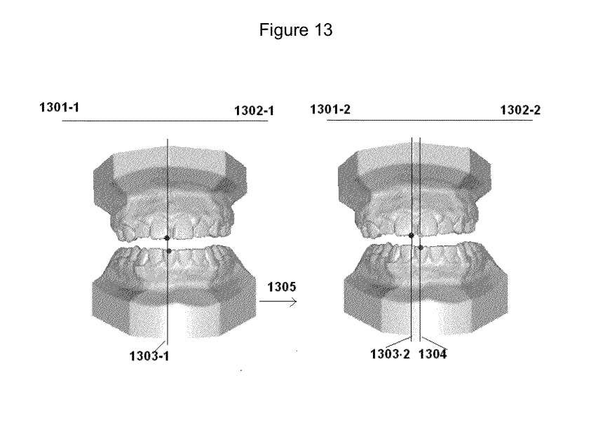

FIG. 13 Lateral excursive movement

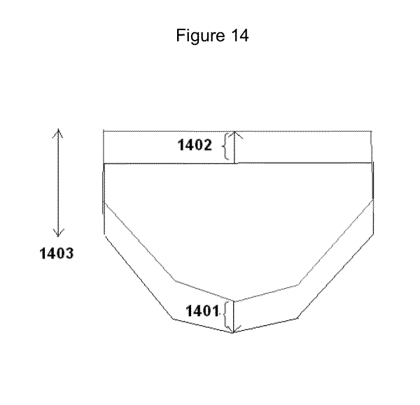

FIG. 14 Protrusive and retrusive movement

### DETAILED DESCRIPTION OF THE INVENTION

For the purposes of this submission, this document will focus on digital dental/orthodontic models, but the uses of the virtual articulator are not limited to digital dental/orthodontic models.

Prior to using the virtual articulator, it is necessary to have access to digital models. Plaster or stone maxillary and mandibular dental arches can be created from impressions provided by the clinician and aligned using a client-provided bite registration. These models are scanned using a laser scanner to create a digital representation of the models. Alternatively, the client may provide a closed-surface stereo lithographic file format of a model for use with the virtual articular. Files from any scanning system that produces three dimensional closed-surface STL or stereo lithographic data format can be processed for use with this invention. A copy of the three dimensional files are stored on a resident server at the originating company and then downloaded to the client's computer.

The virtual articulator opens to the occluded model for the patient selected by the operator (FIG. 3).

The virtual articulator operates as follows:

The operator enters patient-specific measurements for the Condylar angles, Bennett angles and shifts, as well as the limits for the maximum lateral excursive movement, the maximum protrusive movement and maximum mandibular opening which have been made by the clinician (FIG. 4).

The operator selects a manual articulator which has predefined intercondylar distance as well as the measurement for the perpendicular to condylar line for two common manual articulators or enters the patient-specific measurements to customize the articulation.

Once the numerical values for each of the specific anatomical measurements have been entered and the type of articulator is selected, the operator marks one static reference point on the maxillary arch and one static reference point on the mandibular arch of the three dimensional digital model. These points are used as dynamic guidance points in the function of the virtual articulator.

The operator initiates the articulation function and is then able to manipulate the mandible. When the maximum limits of movement as defined by the customized fields have been reached, an audible tone sounds to alert the operator. The virtual articulator allows the operator to turn and rotate the virtual model to any position in 360 degrees and to initiate and view virtual mandibular movement from any and every angle.

Upon opening and then closing the virtual mandible in relation to the virtual maxilla on the digital models, a small coloured mark indicates the first point of contact between the dynamic surfaces of the two components (FIG. 5).

When the virtual mandible is moved in such a way as to cause the dynamic surfaces of the two components to touch, the interference marks between the dynamic surfaces are indicated by a series of coloured polygons (FIG. 6). The number and size of the coloured polygons will vary with the degree of interference between the dynamic surfaces of the virtual arches. A light degree interference between the dynamic surfaces results in smaller, lighter clusters of polygons, while a greater degree of interference results in a larger number of polygons which may range over a larger area or may be a heavier cluster of polygons in a small area. The interference patterns are recorded whether the movement is on the working side or the non working side of the virtual mandible.

The virtual articulator simulates any patient's unique mandibular range of motion based on the individual's measurements and movement limits. A series of polygons is formed based on the customized data. A visual representation of the polygons (FIG. 7) can be activated.

The full range of motion of a patient's mandible is complex. Using the patient-specific measurements input by the operator, the virtual articulator creates a curvilinear mandibular range of motion polygon in which the virtual mandible can be moved. FIG. 8 illustrates the shape of curvilinear mandibular range of motion as viewed from the front, while FIG. 9 illustrates the side view of the shape of the curvilinear mandibular range of motion.

This invention uses the values that are patient-specific to clearly delineate an individual's mandibular range of motion. As the operator opens the digital mandible, the left and right lateral excursive movements will progressively have smaller deflections as the mandible moves to the maximum range of opening, as is illustrated in FIG. 8, 805, and FIG. 9, 908.

As pertains to the motion of the digital model and the measurement variables for the virtual articulator, the input variables are defined and the effects of variations affected by each movement are outlined:

Condylar Angle

The condylar angle (FIG. 10) is the angle created by two tangential lines. The first line (1004) is on the slope of the posterior surface of the articular eminence (1001). The second line (1002) is a horizontal reference line drawn parallel to the transverse plane that is tangential to the deepest point with in the articular fossa (1003). The condylar angle is created by the intersection of these lines (1005) and is a guiding factor in determining the steepness of the angle of opening and closing of the mandible. The left and right condylar angles affect the location of the first point of contact between the maxillary and mandibular arches, as well as the location and pattern of surface interferences between the two arches. In either the CR or CO position, a hinge axis of opening, with no protrusive movement of the virtual mandible to the maximum point of opening (FIG. 8, 805 and FIG. 9, 908) forms the left and right posterior borders of the mandibular range of motion (FIG. 8, 808 and 809, FIG. 9, 911 and 912 or 917 and 918). The anterior border of the mandibular range of motion (FIG. 8, 804, FIG. 9, 907) is formed as the mandible opens to its maximum limit of opening (FIG. 10, 805 and FIG. 9, 908) from the maximum protrusive position (FIG. 8, 803, FIG. 9, 906).

The Bennett Angle

The Bennett Angle (FIG. 11, 1103) is created by the advancing condyle (1102) during lateral movement of the mandible in the sagittal plane. The opposing condyle (1101) rotates and creates a path of movement (1104) in the transverse, sagittal, and coronal planes. The angle can be illustrated by drawing a line through the condyle parallel to a point aligned with the side of a patient's mandible (1105), and the line created by drawing a line to the same point on the patient's mandible after movement (1106).

Changes to the Bennett angle will affect where the interferences of the mandibular and maxillary arches begin and end, and will also change the location of first point of contact. Increasing the Bennett angle will also alter the angle of rotation as the digital mandible moves to the left or right. Furthermore, the Bennett angle will establish the lateral most limits of the curvilinear mandibular range of motion (FIG. 8, 810 and 811 and FIG. 9, 913 and 914).

Bennett Shift

The Bennett Shift is the lateral movement of the condyles within the articular fossa during lateral excursive movement (FIG. 12, 1203 to 1204) while moving in the direction noted by 1205. The immediate Bennett shift will have an impact on the interference of the crowns. A large Bennett shift will result in shallower posterior crown morphology. Increasing the Bennett shift will change the interference patterns for left and right lateral excursive movements and may also impact the first point of contact.

The measurements to be entered into the fields for Maximum Lateral Excursive Movement, Protrusive and Retrusive Movement, and for Maximum Mandibular Movement are the maximum limits of the mandibular range of motion (FIG. 4).

Maximum Lateral Excursive Movement

Maximum lateral excursive movements are the right and left movement on the transverse axis by the digital mandible as measured by the distance travelled by an arbitrary point marked on the incisal, point 1303-2 to point 1304 in FIG. 13, and as illustrated in FIG. 8, 806 and 807 and FIG. 9, 909 and 910. This illustration indicates the direction of motion as left (1305) for demonstration purposes. When the direction of motion is to the right, point 1304 would be to the left of point 1303-2. In FIG. 8, lines 810 and 811, and in FIG. 9, lines 913 and 914 are the curvilinear paths upon which points 803 or 906 moves when moving to the maximum left or right maximum lateral excursive positions.

Protrusive and Retrusive Movement

Protrusive (FIG. 14, 1401,) and retrusive (FIG. 14, 1402) movements are the forward and return motion (1403) of the digital mandible. In the virtual articulator, the measurements entered into these fields represent the furthest forward movement limit and establishes the anterior border of the retrusive movement for the virtual mandible. When the virtual mandible is in the most protrusive position, the anterior border is defined in FIG. 8, 804, which is the curvilinear path upon which point 803 travels as the virtual mandible moves towards the maximum mandibular open position 805. In FIG. 9, these points are 907, 906, and 908, respectively

Maximum Mandibular Opening

The maximum mandibular opening is the distance from the maxillary incisal tip (FIG. 2, 203, FIG. 8, 803 and FIG. 9, 906) to the mandibular incisal tip in the most open position of the virtual mandible (FIG. 2, 206, FIG. 10, 805 and FIG. 9, 908). The right and left lateral border in the mandibular range of motion and the anterior border of the range of motion, which begins from the most protrusive position, will converge to one point that represents the maximum mandibular opening (FIG. 8, 805 and FIG. 9, 908). In FIG. 8, lines 808 and 809 are the curvilinear paths upon which points 806 and 807 move while the virtual mandible moves towards the maximum mandibular opening (805) while in the CO position. In FIG. 9, Lines 917 and 918 and points 915 and 916 are the same respective points when the mandible is in the CR position.

Anatomical variations have been shown to have an impact on dental and medical diagnosis and treatment planning, which includes but is not limited to the fabrication of accurate dental restorations and appliances, creation of orthognathic surgical treatment plans, determination of surgical implant positioning and fabrication of implant prostheses, crowns, bridges, dentures, partial dentures, implant placement or designs.

With the development of technology for virtual representations of a patient's anatomy and mandibular range of motion for medical and dental purposes, there is a need to develop accurate virtual tools to replace the traditional tools and methods of measuring and recording patient data. This invention exceeds the functionality of currently available virtual tools because of the customizable range of variables that no other individual virtual articulator encompasses.

### Detailed Description of the Illustrations

FIG. 1 is an illustration of the anatomy of the Temporomandibular joint, where:
101 is the mandible
102 is the Condyle
103 is the temporal bone
104 is the Articular eminence
105 is the Articular fossa
106 is the Articular disc
107 is the Superior and Inferior Lateral Pterygoid muscles
108 is the Retrodiscal tissues

FIG. 2 is the Range of Motion polygon, where:
201 is the Right Condyle
202 is the Left Condyle
203 marks the starting point of either CO or CR articulation of the maxillary and mandibular digital models
204 is the furthest distance that 203 can move during left lateral excursive movement of the mandible
205 is the furthest distance that 203 can move during right lateral excursive movement of the mandible
206 is the maximum mandibular opening, or the furthest point that the mandible can move when opening.
207 is the curvilinear path followed by point 203 during left lateral excursive movement.
208 is the curvilinear path that point 203 follows during right lateral excursive movement
209 is the curvilinear path that point 205 follows while the mandible moves from the closed to open position. This line represents the maximum mandibular range of motion when the mandible is kept at the extreme left limits of the lateral excursive position while the mandible is opening.
210 is the curvilinear path that point 204 follows while the mandible moves from the closed to open position. This line represents the maximum mandibular range of motion when the mandible is kept at the extreme right limits of the lateral excursive position while the mandible is opening.
211 is the anterior path that point 203 follows while the mandible moves from the closed to open position from the maximum protrusive position.

FIG. 3 is virtual articulator screen with standard digital model, in which:
The digital model is displayed on the screen in its default occlusion.
The fields for the patient-specific measurements that are to be entered:
   Condylar Angle (Degree) Left and Right
   Bennett Angle (Degree) Left and Right
   Bennett Shift (mm) Left and Right
   Maximum Lateral Excursive (mm) Left and Right
   Maximum Protrusive (mm)
   Maximum Mandibular Opening (mm)

FIG. 4 is an image of the left panel section of the articulator view screen in which the operator enters personalized and customizable patient-specific the measurements, including:
Condylar Angle (Degree) Left and Right
Bennett Angle (Degree) Left and Right
Bennett Shift (mm) Left and Right
Maximum Lateral Excursive (mm) Left and Right
Maximum Protrusive (mm)
Maximum Mandibular Opening (mm)

FIG. 5 is a cutout image the maxillary and mandibular arches showing posterior molars with a coloured mark that indicates the first point of contact upon closing the bite

FIG. 6 is an image of a digital model on which the interference points between the dynamic surface of the virtual maxilla and virtual mandible caused by movement of the virtual mandible are indicated by coloured marks.

FIG. 7 is an image of the digital model in its open state surrounded by the visual Range of Motion polygons that have been defined by the patient-specific measurements and selections.

FIG. 8 is a diagram of the Mandibular Range of Motion, viewed from the front, where:
801 represents the position of the mandible when sitting in the Centric Relation (CR) position.
802 represents the position of the mandible when sitting in the Centric Occlusion (CO) position.
803 marks the point on the central mandibular incisor when the mandible is positioned at the Maximum protrusive position.
804 is the Anterior border of mandibular opening, which is the path which point 803 will follow when the mandible is moving towards the point of Maximum Mandibular Opening.
805 is the furthest point which is attainable by point 803 at the Maximum Mandibular Opening
806 is the furthest point attainable by point 803 when the mandible has reached the Maximum range of left lateral excursive movement.
807 is the furthest point attainable by point 803 when the mandible has reached the Maximum range of right lateral excursive movement
808 is the path that point 806 will follow while the mandible stays at the Maximum range of left lateral excursive position and is moving towards the Maximum Mandibular Opening (805). This line marks the posterior border of the mandibular range of motion on the left side.
809 is the path that point 807 will follow while the mandible stays at the Maximum range of right lateral excursive position and is moving towards the Maximum Mandibular Opening (805). This line marks the posterior border of the mandibular range of motion on the right side
810 is the path followed by point 803 when the mandible stays at the Maximum protrusive position while moving to the maximum left lateral excursive mandibular range of motion
811 is the path followed by point 803 when the mandible stays at the Maximum protrusive position while moving to the maximum right lateral excursive mandibular range of motion

FIG. 9 is a diagram of the Mandibular Range of Motion viewed from the side, where
901 represents the position of the mandible when sitting in the Centric Relation position.
902 represents the position of the mandible when sitting in the Centric Occlusion position.
903 represents the horizontal movement of the mandibular and maxillary incisal edges as they touch each other while in moving protrusively.
904 represents the horizontal movement of the mandibular and maxillary incisal edges as they pass the maxillary incisal edges while moving protrusively.
905 represents the superior movement of the mandibular incisors as they pass the maxillary incisors while moving protrusively.
906 marks the point on the central mandibular incisor when the mandible is positioned at the maximum protrusive position.
907 is the anterior border of mandibular opening, which is the path which point 906 will follow when the mandible is moving towards the point of Maximum Mandibular Opening (908).
908 is the furthest point which is attainable by point 906 at the Maximum Mandibular Opening
909 is the furthest point attainable by point 906 when the mandible has reached the Maximum range of left lateral excursive movement from the CO position.
910 is the furthest point attainable by point 906 when the mandible has reached the Maximum range of right lateral excursive movement from the CO position
911 is the path that point 909 will follow while the mandible stays at the Maximum range of left lateral excursive position and is moving towards the Maximum Mandibular Opening (908) from the CO position. This line marks the posterior border of the mandibular range of motion on the left side.
912 is the path that point 910 will follow while the mandible stays at the Maximum range of right lateral excursive position and is moving towards the Maximum Mandibular Opening (908) from the CO position. This line marks the posterior border of the mandibular range of motion on the right side
913 is the path followed by point 906 when the mandible stays at the Maximum protrusive position while moving to the Maximum left lateral excursive mandibular range of motion to 909.
914 is the path followed by point 906 when the mandible stays at the Maximum protrusive position while moving to the Maximum right lateral excursive mandibular range of motion to 910.
915 is the furthest point attainable by point 906 when the mandible has reached the Maximum range of left lateral excursive movement from the CR position.
916 is the furthest point attainable by point 906 when the mandible has reached the Maximum range of right lateral excursive movement from the CR position
917 is the path that point 909 will follow while the mandible stays at the Maximum range of left lateral excursive position and is moving towards the Maximum Mandibular Opening (908) from the CR position. This line marks the posterior border of the mandibular range of motion on the left side.
918 is the path that point 910 will follow while the mandible stays at the Maximum range of right lateral excursive position and is moving towards the Maximum Mandibular Opening (908) from the CR position. This line marks the posterior border of the mandibular range of motion on the right side.

FIG. 10 is an illustration of the condylar angle as it is visualized from the sagittal view, where: 1001 Articular eminence
1002 Horizontal reference line
1003 Highest point in the articular fossa
1004 Tangential line of the posterior border of the articular eminence
1005 Condylar angle

FIG. 11 is a diagram demonstrating the Bennett angle where:
1101 is the rotational condyle
1102 is the orbiting condyle
1103 is the Bennett Angle
1104 is the direction of movement
1105 is the line drawn through the condyle parallel to a point aligned with the side of a patient's mandible before movement
1106 is the line drawn through the same point on the patient's mandible after movement

Note: this diagram represents the left condyle as the working condyle and defines the left Bennett angle and is a result of the shift from the z-axis due to movement of left side of jaw to the right. In the case where the right condyle is the working condyle, the same types of measurements will result in the calculation of the right Bennett angle.

FIG. 12 is a diagram demonstrating the left Bennett shift, where:
1201 is the right condyle
1202 is the left condyle
1203-1 and -2 are the points on the condyles before affecting the Bennett shift
1204-1 and -2 are the same points on the condyles after affecting the Bennett shift
1205 is the direction of movement.

Note: the right Bennett shift occurs when the direction of movement is to the patient's right. In this case, points 1204-1 and 1204-2 would be to the left of points 1203-1 and 1203-2 in FIG. 12.

FIG. 13 is an illustration of how the excursive lateral movement viewed on the coronal plane where:
1301-1 and -2 are the right condyle
1302-1 and -2 are the left condyle
1303-1 is the originating point before the excursive lateral movement
1303-2 is the originating point before the excursive lateral movement
1304 is the position of point A after the excursive lateral movement
1305 is the direction of movement
1303-2 to 1304 is the distance of the excursive lateral movement
1305 is the direction of movement

Note: Movement in this illustration is laterally to the patient's left. Movement to the right would result in point 1304 being on the left of point 1303-2.

FIG. 14 is a diagram demonstrating the protrusive and retrusive movements viewed on the transverse plane where:
1401 is the distance of protrusive movement of the virtual mandible
1402 is the distance of retrusive movement of the virtual mandible
1403 is the direction of movement, either forward or back

### REFERENCES CITED

U.S. Patent Documents

| | | |
|---|---|---|
| 7347690 | March 2008 | Jordan et al |
| 7435083 | October 2008 | Chishti et al |
| 7474307 | January 2009 | Chishti et al |
| 7690919 | April 2010 | Huffman |
| 7714024 | May 2010 | Hultgren et al |
| 7734368 | June 2010 | Kopelman et |
| al | | |
| 7824346 | November 2010 | Marshall |
| 7857622 | December 2010 | Lee |
| 7942671 | May 2011 | Taub |
| 8013853 | September 2011 | Douglas et al |
| 8029277 | October 2011 | Imgrund et al |
| 8041439 | October 2011 | Kopelman et |
| al | | |
| 8047846 | November 2011 | Wen |
| 8047847 | November 2011 | Kaufman et |
| al | | |
| 8075306 | December 2011 | Kitching et al |

Canadian Patent Documents

| | | |
|---|---|---|
| 1280629 | August 1985 | Suganuma et |
| al | | |
| 280917 | April 1993 | Westdyk |
| 2160792 | August 1995 | Andersson |
| 2220218 | May 1996 | Huffman |
| 2350849 | June 2001 | Not identified |
| 2450699 | December 2003 | Perot et at |

### OTHER REFERENCES AND CITATIONS

Abdullah, M. and Al-Shammery, A, The relation of semi-adjustable articulators to clinical outcome—A review Saudi Dental Journal; Vol. 14, No. 1, January-April 2002, pp. 39-46.

Hatice, et al, Correlation between eminence steepness and condyle disc movements in temporomandibular joints with internal derangements on magnetic resonance imaging, European Journal of Orthodontics, 23, 2001, pp 579-584

Katsavrias, Changes in Articular Eminence Inclination During the Craniofacial Growth Period, The Angle Orthodontist, Volume 72, Number 3, pp 258-264.

Mito et al, Mandibular Lateral Translation during Symmetric Mandibular Movement, The International Journal of Stomatology and Occlusion Medicine, Volume 2, Number 1, January 2009, pp 24-31.

Okeson, Jeffrey P, Management of Temporomandibular Disorders and Occlusion, Second Edition, The CV Masby Company, 1989

Olthoff, et al, Computer Modeling of Occlusal Surfaces of Posterior Teeth with the CICERO CAD/CAM System, The Journal of Prosthetic Dentistry, Volume 84, Number 2, August 2000, pp 154-162.

Poschel, et al, Articulatro-Related Registration—A simple Concept for Minimizing Eccentric Occlusal Erros in the Articular, The International Journal of Prosthodontics, vol. 15, No. 3, Nov. 3, 2002, pp 289-294

Sumiya, et al, Fixed Prosthodontics Operative Dentistry, Articulator Selection for Restorative Dentistry, Beaudreau et al, editors, Journal of Prosthodontic Dentistry, Volume 36, Number 1, July 1976, pp 35-43.

The embodiments of the invention in which an exclusive property or privilege is claimed are defined as follows:

1. A method for articulating three dimensional digital or virtual models by adjusting the position of the virtual mandible in relation to the virtual maxilla.

2. The method of claim 1, further comprising of a method on which to personalize and customize patient-specific movement parameters for:
a. each of the left and right condylar angles
b. each of the left and right Bennett angles
c. each of the left and right Bennett shifts
d. each of the left and right Maximum Lateral Excursive movement limits
e. the Maximum Protrusive movement limit
f. the Maximum Mandibular Opening limit,
such that the mandibular movement more accurately simulates the patient's actual physical movement of the mandible in relation to the maxilla.

3. Further to claim 2, including the provision of an optional selection of preset measurements for intercondylar distance and the perpendicular to the condylar line or the operator can select a custom option whereby the operator can enter the patient-specific measurements for the intercondylar distance and the Perpendicular to condylar line.

4. The method of claim 2 whereby the operator indicates a static reference point on each of the virtual maxillary and virtual mandibular arches whereby the static reference points are utilized by the virtual articulator as dynamic guidance points for patient-specific movement of the virtual mandible in relation to the virtual maxilla.

5. Further to claims 2 to 4, once the articulation function has been activated, the operator is able to rotate the digital models 360 degrees in any direction within the three dimensions on the x, y and z axes.

6. Further to claim 5, once the articulation function has been activated, the operator can cause the virtual image of the three dimensional digital model to increase or decrease in size, and this can be done in any configuration or angle the operator is viewing in the virtual articulator.

7. Further to claim 1, the movement of the virtual mandible in relation to the virtual maxilla for the digital models is enacted from the virtual temporomandibular joints as per the parameters identified by the operator as in claims 2-4.

8. Further to claim 7, the operator is able to move the virtual mandible in relation to the virtual maxilla in any direction or combination of directions on the x, y and z axes, such as:
a. right or left lateral excursive movements,
b. right or left Bennett shift,
c. protrusive and retrusive
d. movements, and open and closing

9. Further to claims 7 and 8, the re-articulated digital models can be rotated in 360 degrees to view the digital models after each of and any combination of movements within the three dimensional axes of the x, y and z axes.

10. Further to claims 7 and 8, changes to each and any of the patient-specific measurements entered as in claims 2-4 will cause a change in the direction, degree of movement and movement limitations of the virtual mandible in relation to the virtual maxilla.

11. Further to claims 7, 8 and 10, movement of the virtual mandible in relation to the virtual maxilla will cause a coloured mark on the dynamic surface of the digital model, on, but not limited to, the virtual mandible that indicates the first point of contact between the dynamic surfaces on either the working or non-working side of the virtual mandible.

12. Further to claims 7, 9 and 10, movement of the virtual mandible in relation to the virtual maxilla will cause a series of coloured marks on the dynamic surface of the digital model, on, but not limited to, the virtual mandible that indicates the surface interferences between the dynamic surfaces as a result of movement on either the working or non-working side of the virtual mandible.

13. Further to claims 2 and 3, the entry of patient-specific measurements upon which the patient's mandibular movement is simulated creates a series of polygons that define the limits of the range of motion and is a function of the patient-specific measurements provided by the client. The shape and size of the polygons will vary according to the patient-specific measurements provided by the client.

14. Further to claim 13, when manipulating the virtual mandible, audible tones will sound when maximum limits as set per the measurements outlined in claims 2-4 have been hit or exceeded and a visual warning of the violation of the maximum limit that has been exceeded will appear on the screen.
This invention has been described in detail in this document with the embodiments thereof with reference to accompanying illustrations and drawings that are use to clarify the concepts pertinent to the invention. The embodiment and the claims of this invention were described in the context of dentistry, prosthodontics, endodontics, periodontics, orthodontics and oral surgery. However there are several combinations and alterations to the designs that can be made to change the use of this invention that can be applied to but not limited to other fields such as medicine, three dimensional cad/cam designs, milling, manufacturing, and aeronautics, which use the specifications that are herein described for this invention. It will be understood that the embodiments are representative and that a variety of modifications, substitutions and alterations are possible without departing from the spirit and scope of the present invention for those who are skilled in the art and field, and who can conceive these changes to the embodiments and applications in different sectors. This invention can be utilized as a process, an embodiment of a system, or a computer generated diagnostic tool. It is understood that variation of uses of this invention includes uses in fields that are not described in this disclosure to which the invention pertains and may be applied herein set forth and follows the scope of the claims.
